(19) United States
(12) Patent Application Publication
(10) Pub. No.: US 2024/0152344 A1
(43) Pub. Date: May 9, 2024

(54) SERVICE DRIVEN FIRMWARE UPGRADE METHODOLOGY IN BMC

(71) Applicant: American Megatrends International, LLC, Duluth, GA (US)

(72) Inventors: Venkatesan Balakrishnan, Chennai (IN); Chitrak Gupta, Kolkata (IN); Anurag Bhatia, Sugar Hill, GA (US)

(21) Appl. No.: 17/980,803

(22) Filed: Nov. 4, 2022

(51) Int. Cl. G06F 8/65; G06F 8/61

(52) U.S. Cl. CPC G06F 8/65; G06F 8/61

(57) ABSTRACT

In an aspect of the disclosure, a method, a computer-readable medium, and a BMC are provided. The BMC receives an update package containing one or more updated software components of a firmware image of the BMC. The BMC determines that a first group of components of the one or more updated software components are service components. The BMC creates a first layer on top of existing layers in an overlay file system. The first layer contains the first group of updated software components.

### BACKGROUND

### Field

The present disclosure relates generally to computer systems, and more particularly, to techniques of service driven firmware upgrade in baseboard management controller (BMC).

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Not all host systems have the hardware capability for service processors to access storages of component devices (e.g., a Serial Peripheral Interface (SPI) storages) directly or communicate with the component devices. Therefore, there is a need for a mechanism for updating firmware of the component devices conveniently.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a BMC are provided. The BMC receives an update package containing one or more updated software components of a firmware image of the BMC. The BMC determines that a group of updated software components of the one or more updated software components are updateable base on a configuration. The BMC stores the group of updated software components in a read/write partition. A respective link associated with each of the group of updated software components exists in a read-only partition.

In another aspect of the disclosure, a method, a computer-readable medium, and a BMC are provided. The BMC receives an update package containing one or more updated software components of a firmware image of the BMC. The BMC determines that a first group of components of the one or more updated software components are service components. The BMC creates a first layer on top of existing layers in an overlay file system. The first layer contains the first group of updated software components.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system.

FIG. 2 is a diagram illustrating a first technique of service driven firmware upgrade.

FIG. 3 is a diagram illustrating data flows of firmware updates in accordance with the first technique.

FIG. 4 is a diagram illustrating a second technique of service driven firmware upgrade.

FIG. 5 is a diagram illustrating data flows of firmware updates in accordance with the second technique.

FIG. 6 shows a computer architecture for a computer.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

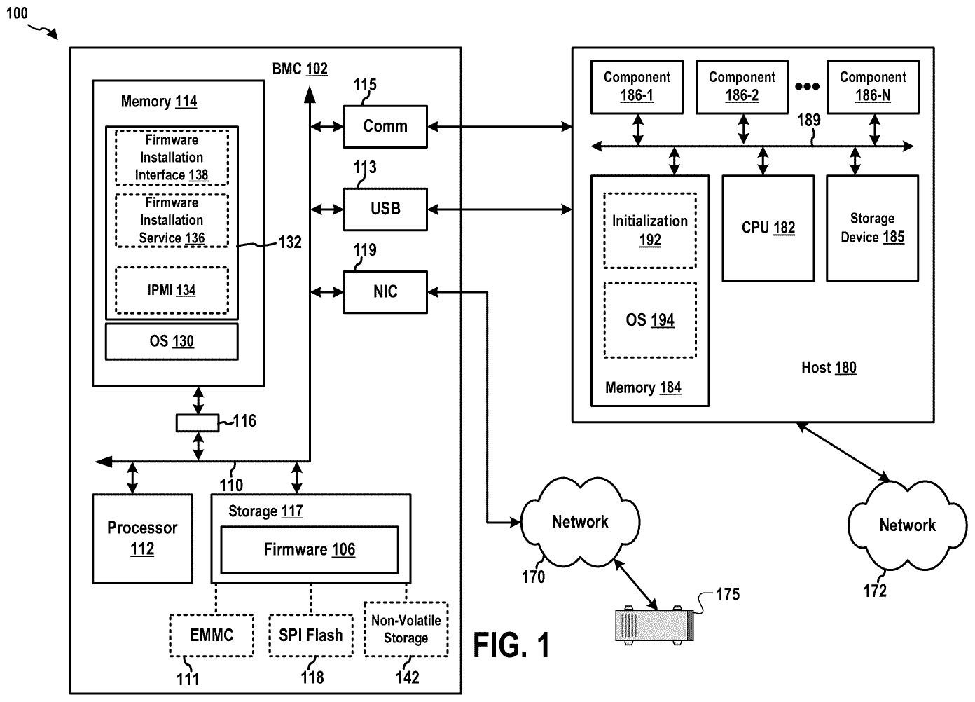

FIG. 1 is a diagram illustrating a computer system 100. In this example, the computer system includes, among other devices, a BMC 102 and a host computer 180. The BMC 102 has, among other components, a processing unit 112, a memory 114, a memory driver 116, a storage 117, a network interface card 119, a USB interface 113 (Universal Serial Bus), and other communication interfaces 115.

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the processing unit 112, the memory 114, the memory driver 116, the storage 117, the network interface card 119, the USB interface 113, and/or the communication interfaces 115 may be on the same chip. In addition, the memory 114, the processing unit 112, the memory driver 116, the storage 117, the communication interfaces 115, and/or the network interface card 119 may be in communication with each other through a communication channel 110 such as a bus architecture.

The BMC 102 may store BMC firmware image 106 in the storage 117. The storage 117 may utilize a non-volatile, non-transitory storage media. The storage 117 may also include an embedded multimedia card (EMMC) 111, an SPI flash device 118, and/or a non-volatile storage 142, all of which may be used to store the BMC firmware image 106. When the processing unit 112 executes the BMC firmware image 106, the processing unit 112 loads code and data of the BMC firmware image 106 into the memory 114. In particular, the BMC firmware image 106 can provide in the memory 114 an OS 130 (operating system) and service components 132. The service components 132 include, among other components, IPMI services 134, a firmware installation service 136, and a firmware installation interface 138. Further, the service components 132 may be implemented as a service stack. As such, the BMC firmware image 106 can provide an embedded system to the BMC 102.

The BMC 102 may be in communication with the host computer 180 through the USB interface 113, the network interface card 119, the communication interfaces 115, and/or the IPMI interface.

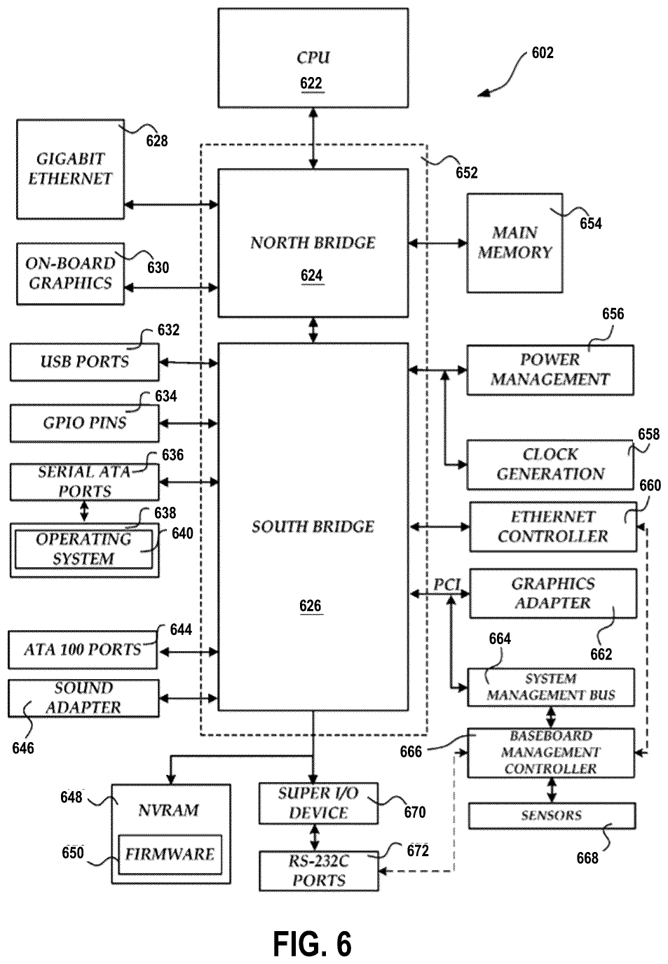

The host computer 180 includes a host CPU 182, a host memory 184, a storage device 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller. Further, the component devices 186-1 to 186-N can include hardware components of a computer 602 shown in FIG. 6.

After the host computer 180 is powered on, the host CPU 182 loads an initialization component 192 from the storage device 185 into the host memory 184 and executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device 185, usually a hard disk of the storage device 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

As described supra, a BMC (e.g., the BMC 102) may runs as an SOC with its own firmware (e.g., the BMC firmware image 106). The firmware may include a complete operating system (e.g., embedded Linux) and a set of applications that provide management functions. A BMC over its lifetime undergoes multiple firmware updates that adds features or provides fixes to issues. Firmware updates of the BMC may result in server downtime, as the whole BMC firmware image 106 needs to be flashed. In certain scenarios, the base portions of the firmware such as a Linux Kernel, a bootloader and kernel modules may not undergo any change. In most cases, firmware updates are directed to bug fixes or feature enhancements/additions. Therefore, only certain components of the firmware need to be updated. There is no need to install a complete firmware image every time.

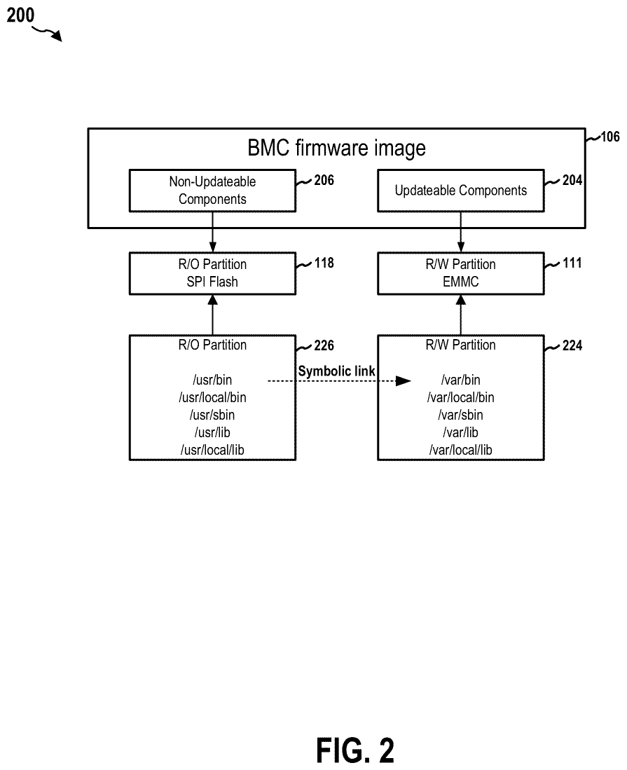

FIG. 2 is a diagram 200 illustrating a first technique of service driven firmware upgrade. In particular, the components of the BMC firmware image 106 may be mounted on different filesystems. The BMC firmware image 106 may be segregated into updateable components 204 that need to be updated frequently (e.g., certain library files) and non-updateable components 206 that do not need to be updated frequently (e.g., certain immutable components).

When the BMC firmware image 106 is initially loaded to components of the storage 117 by an installation service, the installation service may install the updateable components 204 in a read/write (R/W) media such as the EMMC 111 and install the non-updateable components 206 in a read only (R/O) media such as the SPI flash device 118.

More specifically, installation packages containing the non-updateable components 206 are marked as non-updateable. Accordingly, the binary files from those installation packages are stored in the SPI flash device 118. Further, the SPI flash device 118 corresponds to a R/O partition 226 (e.g., /usr directory) of a file system created for the BMC 102. Accordingly, the non-updateable components 206 are stored in the /usr directory of the file system.

Installation packages containing the updateable components 204 are marked as updateable. Accordingly, the binary files from those installation packages are stored in the EMMC 111. Further, the EMMC 111 corresponds to a R/W partition 224 (e.g., /var directory) of the file system created for the BMC 102. Accordingly, each of the updateable components 206 is stored in the /var directory of the file system. Further, a respective symbolic link for each component is created in the /usr directory of the R/O partition 226. When the BMC 102 boots and a loader of the BMC 102 attempts to load binaries stored in the /usr directory (i.e., the R/W partition 224), the loader may detect that the file stored in the /usr directory is a symbolic link pointing to a file stored in the \var directory (i.e., the R/O partition 226). Accordingly, the loader loads the corresponding file from the \var directory.

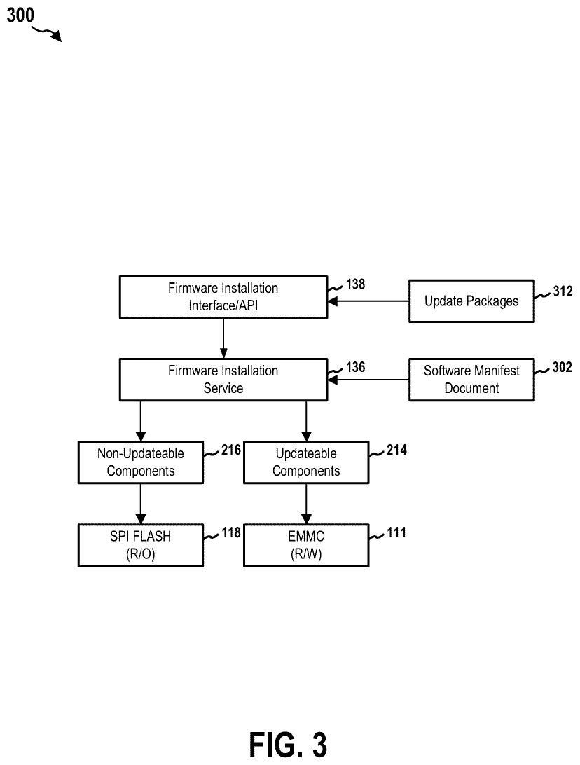

FIG. 3 is a diagram 300 illustrating data flows of firmware updates in accordance with the first technique. As described supra, the firmware installation interface 138 and the firmware installation service 136 run on the BMC 102. The firmware installation interface 138 may provide a REDFISH API or a web interface. The firmware installation interface 138 receives, e.g., from the remote device 175, firmware update packages 312 for an update of the BMC firmware image 106. The firmware installation interface 138 send the firmware update packages 312 to the firmware installation service 136. The firmware installation service 136 is configured with a software manifest 302 or the firmware update packages 312 contains a software manifest 302. The firmware installation service 136 checks the updateable flag in the software manifest 302 to determine the updateable components 204 and the non-updateable components 206 contained in the firmware update packages 312. At this time, the firmware installation service 136 only allows installation of the updateable components 204.

If a component of the updateable components 204 contained in the firmware update packages 312 already exists in the R/W partition 224, the firmware installation service 136 replaces the existing component with the updated one contained in the firmware update packages 312. If the component does not exist in the R/W partition 224, the firmware installation service 136 writes the component to the R/W partition 224 and creates a symbolic link in the R/O partition 226. In certain configurations, the firmware installation service 136 may discard the non-updateable components 206 contained in the firmware update packages 312. As such, when the BMC 102 boots next time, the loader of the BMC 102 loads the updated components (as indicated by the symbolic links) from the R/W partition 224. As shown, with support from EMMC devices, the BMC 102 can host R/W partitions or the complete rootfs in the EMMC partition. The R/W partition can be standard ext linux file systems.

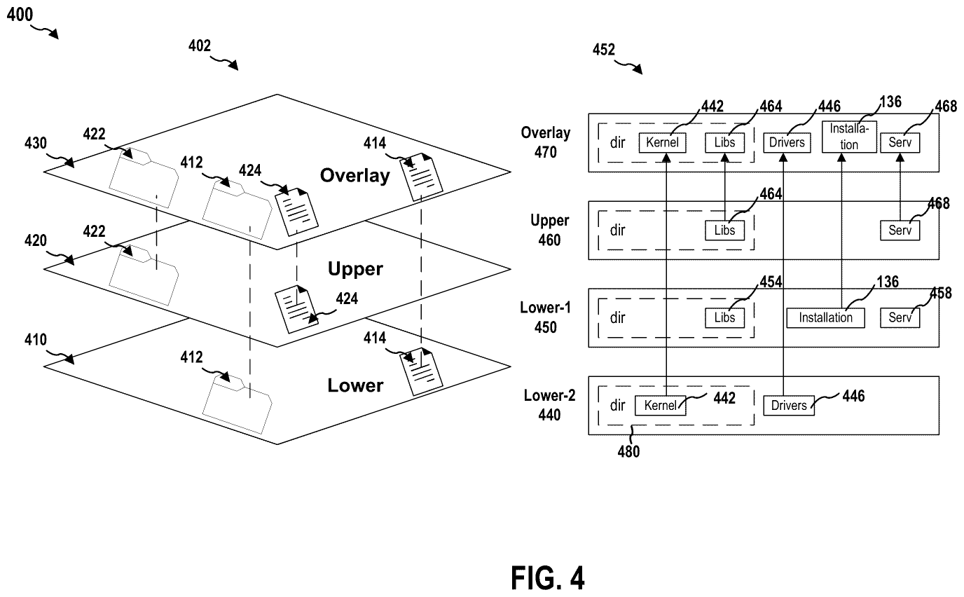

FIG. 4 is a diagram 400 illustrating a second technique of service driven firmware upgrade. An overlay file system 402 contains two or more layers of directories and files and can generate an overlay layer that combines one or more layers together. In this example, the overlay file system 402 has a lower layer 410 and an upper layer 420. The lower layer 410 may include a directory 412 and a file 414. The upper layer 420 may include a directory 422 and a file 424. The overlay layer 430 combines the lower layer 410 and the upper layer 420 and has the directories 412, 422 and the files 414, 424.

In another example, the BMC firmware image 106 is initially installed on an overlay file system 452 having a lower-2 layer 440 and a lower-1 layer 450. The lower-2 layer and the lower-1 layer 450 may be stored in a R/O partition on the SPI flash device 118. The lower-2 layer 440 contains an initial kernel 442 in a directory 480 and initial drivers 446. The lower-1 layer 450 contains initial libraries 454 in the directory 480, the firmware installation service 136, and initial service component 458, etc. The overlay file system 452 combines the lower-1 layer 450 and the lower-2 layer 440 to generate an initial overlay layer. When the BMC 102 initially boots, the loader of the BMC 102 loads those components contained in the lower-2 layer 440 and the lower-1 layer 450.

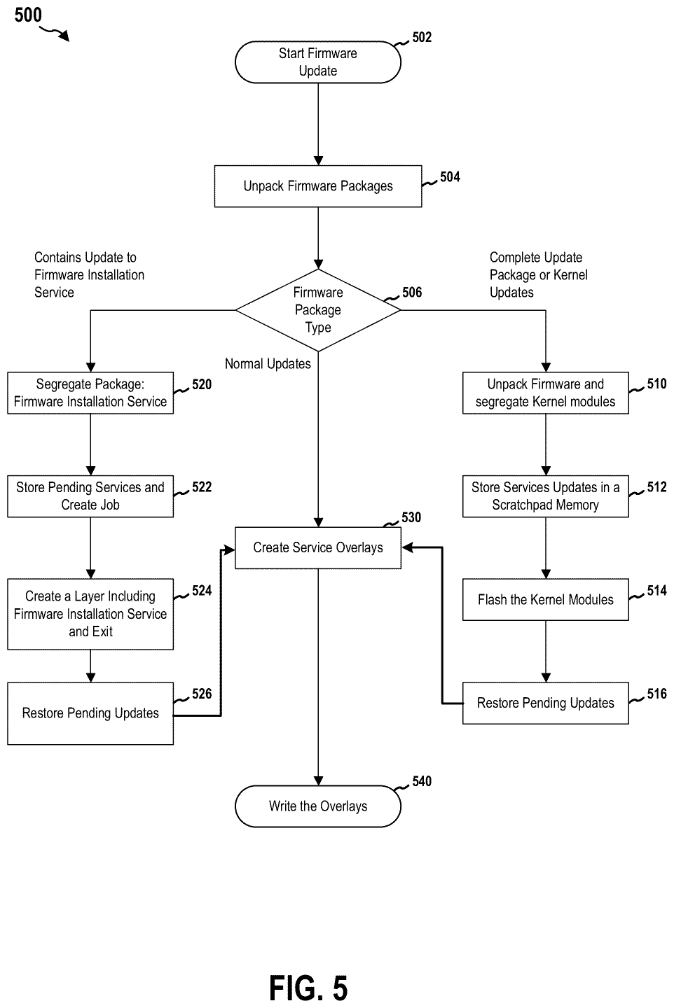

FIG. 5 is a diagram 500 illustrating data flows of firmware updates in accordance with the second technique. At operation 502, the firmware installation interface 138 receives firmware update packages. At operation 504, the firmware installation interface 138 sends the firmware update packages to the firmware installation service 136. The firmware installation service 136 unpacks the firmware update packages. At operation 506, the firmware installation service 136 checks the content of the firmware update packages and determines the type of the update.

Within the operation 506, when the firmware update packages contain updates to the initial kernel 442, the initial drivers 446, or other kernel modules, the firmware installation service 136 determines a complete update needs to be performed and enters operation 510.

At operation 510, the firmware installation service 136 segregates the kernel modules (e.g., the updated kernel or drivers) from the other services updates (e.g., updated libraries 464, an updated service component 468). At operation 512, the firmware installation service 136 stores the other services updates in a scratchpad memory as pending updates. At operation 514, the firmware installation service 136 flashes the part of the R/O partition storing the lower-2 layer 440 with an updated lower-2 layer 440 having the updated kernel 442 and the updated drivers 446. The initial lower-2 layer 440 may be stored in the non-volatile storage 142 to revert to if needed. The BMC 102 then reboots and loads the updated kernel 442 and the updated drivers 446.

At operation 516, the firmware installation service 136 starts on top of the updated kernel 442 and the updated drivers 446. The firmware installation service 136 locates the stored pending updates for the other service components. The firmware installation service 136 then enters operation 530.

Within the operation 506, when the firmware update packages do not contain updates to the initial kernel 442, the initial drivers 446, or other kernel modules, the firmware installation service 136 then determines whether the firmware update packages contain an update to the firmware installation service 136 itself. When the firmware update packages contain an update to the firmware installation service 136, the firmware installation service 136 enters operation 520. Otherwise, the firmware installation service 136 enters operation 530.

At operation 520, the firmware installation service 136 segregates the update to the firmware installation service 136 in the firmware update packages from the updates to other service components. At operation 522, the firmware installation service 136 stores the updates to other service components, for example, in the non-volatile storage 142 and creates pending jobs for the firmware installation service 136 to execute those updates.

At operation 524, the firmware installation service 136 creates new layer on top of the lower-1 layer 450 that contains the updated firmware installation service 136. The running firmware installation service 136 then exits and shuts down its process. At operation 526, the updated firmware installation service 136 starts and locates the stored pending jobs regarding the other service components. In this example, the other service components include the updated libraries 464 and the updated service component 468. Then the firmware installation service 136 enters operation 530.

At operation 530, the firmware installation service 136 creates an upper layer 460 containing the updated libraries 464 and the updated service component 468. At operation 540, the firmware installation service 136 writes the upper layer 460 in a R/W partition (e.g., in the non-volatile storage 142).

As such, the overlay file system 452 contains the updated lower-2 layer 440, the initial lower-1 layer 450, and the upper layer 460. The overlay file system 452 combines those layers and provide an overlay layer 470 that contains the updated kernel 442, the updated libraries 464, the updated drivers 446, the firmware installation service 136, and the updated service component 468, etc.

FIG. 6 and the following discussion are intended to provide a brief, general description of one suitable computing environment in which aspects of the embodiments described herein may be implemented. In particular, FIG. 6 shows a computer architecture for a computer 602 that may be utilized to embody the host computer 180, as described supra. It should be appreciated that the computer architecture shown in FIG. 6 is merely illustrative and that other types of computers and computing devices may also be utilized to implement aspects of the embodiments presented herein.

While aspects presented herein include computer programs that execute in conjunction with the execution of an operating system, those skilled in the art will recognize that the embodiments may also be implemented in combination with other program modules and/or hardware devices. As described herein, computer programs include routines, programs, components, data structures, and other types of structures that perform particular tasks or implement particular abstract data types. Moreover, those skilled in the art will appreciate that the embodiments described herein may be practiced with other computer system configurations, including hand-held devices, multiprocessor systems, microprocessor-based or programmable consumer electronics, minicomputers, mainframe computers, and the like. The embodiments described herein may also be practiced in distributed computing environments where tasks are performed by remote processing devices that are linked through a communications network. In a distributed computing environment, program modules may be located in both local and remote memory storage devices.

The computer 602 shown in FIG. 6 includes a baseboard, or “motherboard,” which is a printed circuit board to which a multitude of components or devices may be connected by way of a system bus or other electrical communication path. In one illustrative embodiment, a CPU 622 operates in conjunction with a chipset 652. The CPU 622 is a standard central processor that performs arithmetic and logical operations necessary for the operation of the computer. The server computer 602 may include a multitude of CPUs 622.

The chipset 652 includes a north bridge 624 and a south bridge 626. The north bridge 624 provides an interface between the CPU 622 and the remainder of the computer 602. The north bridge 624 also provides an interface to a random access memory (“RAM”) used as the main memory 654 in the computer 602 and, possibly, to an on-board graphics adapter 630. The north bridge 624 may also include functionality for providing networking functionality through a gigabit Ethernet adapter 628. The gigabit Ethernet adapter 628 is capable of connecting the computer 602 to another computer via a network. Connections which may be made by the network adapter 628 may include LAN or WAN connections. LAN and WAN networking environments are commonplace in offices, enterprise-wide computer networks, intranets, and the internet. The north bridge 624 is connected to the south bridge 626.

The south bridge 626 is responsible for controlling many of the input/output functions of the computer 602. In particular, the south bridge 626 may provide one or more USB ports 632, a sound adapter 646, an Ethernet controller 660, and one or more GPIO pins 634. The south bridge 626 may also provide a bus for interfacing peripheral card devices such as a graphics adapter 662. In one embodiment, the bus comprises a PCI bus. The south bridge 626 may also provide a system management bus 664 for use in managing the various components of the computer 602. Additional details regarding the operation of the system management bus 664 and its connected components are provided below.

The south bridge 626 is also operative to provide one or more interfaces for connecting mass storage devices to the computer 602. For instance, according to an embodiment, the south bridge 626 includes a serial advanced technology attachment (“SATA”) adapter for providing one or more SATA ports 636 and an ATA 100 adapter for providing one or more ATA 100 ports 644. The SATA ports 636 and the ATA 100 ports 644 may be, in turn, connected to one or more mass storage devices such as the SATA disk drive 638 storing an operating system 640 and application programs.

As known to those skilled in the art, an operating system 640 comprises a set of programs that control operations of a computer and allocation of resources. An application program is software that runs on top of the operating system software, or other runtime environment, and uses computer resources to perform application specific tasks desired by the user. According to one embodiment of the invention, the operating system 640 comprises the LINUX operating system. According to another embodiment of the invention the operating system 640 comprises an operating system within the WINDOWS family of operating systems from MICROSOFT CORPORATION. According to another embodiment, the operating system 640 comprises the UNIX, LINUX, or SOLARIS operating system. It should be appreciated that other operating systems may also be utilized.

The mass storage devices connected to the south bridge 626, and their associated computer storage media, provide non-volatile storage for the computer 602. Although the description of computer storage media contained herein refers to a mass storage device, such as a hard disk or CD-ROM drive, it should be appreciated by those skilled in the art that computer storage media can be any available media that can be accessed by the computer 602.

By way of example, and not limitation, computer storage media may comprise volatile and non-volatile, removable and non-removable media implemented in any method or technology for storage of information such as computer-readable instructions, data structures, program modules or other data. Computer storage media also includes, but is not limited to, RAM, ROM, EPROM, EEPROM, flash memory or other solid state memory technology, CD-ROM, DVD, HD-DVD, BLU-RAY, or other optical storage, magnetic cassettes, magnetic tape, magnetic disk storage or other magnetic storage devices, or any other medium which can be used to store the desired information and which can be accessed by the computer.

According to embodiments, a low pin count (“LPC”) interface may also be provided by the south bridge 626 for connecting a “Super I/O” device 670. The Super I/O device 670 is responsible for providing a number of input/output ports, including a keyboard port, a mouse port, a serial interface 672, a parallel port, and other types of input/output ports. The LPC interface may also connect a computer storage media such as a ROM or a flash memory such as a NVRAM 648 for storing the firmware 650 that includes program code containing the basic routines that help to start up the computer 602 and to transfer information between elements within the computer 602.

As described briefly above, the south bridge 626 may include a system management bus 664. The system management bus 664 may include a BMC 666. The BMC 666 may be the BMC 102. In general, the BMC 666 is a microcontroller that monitors operation of the computer system 602. In a more specific embodiment, the BMC 666 monitors health-related aspects associated with the computer system 602, such as, but not limited to, the temperature of one or more components of the computer system 602, speed of rotational components (e.g., spindle motor, CPU Fan, etc.) within the system, the voltage across or applied to one or more components within the system 602, and the available or used capacity of memory devices within the system 602. To accomplish these monitoring functions, the BMC 666 is communicatively connected to one or more components by way of the management bus 664. In an embodiment, these components include sensor devices 668 for measuring various operating and performance-related parameters within the computer system 602. The sensor devices 668 may be either hardware or software based components configured or programmed to measure or detect one or more of the various operating and performance-related parameters.

It should also be appreciated that the computer 602 may comprise other types of computing devices, including hand-held computers, embedded computer systems, personal digital assistants, and other types of computing devices known to those skilled in the art. It is also contemplated that the computer 602 may not include all of the components shown in FIG. 6, may include other components that are not explicitly shown in FIG. 6, or may utilize an architecture completely different than that shown in FIG. 6.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operating a baseboard management controller (BMC), comprising:
receiving, at the BMC, an update package containing one or more updated software components of a firmware image of the BMC;
determining that a group of updated software components of the one or more updated software components are updateable base on a configuration; and
storing the group of updated software components in a read/write partition, wherein a respective link associated with each of the group of updated software components exists in a read-only partition.

2. The method of claim 1, wherein one or more software components, of the firmware image, that are non-updateable are stored in the read-only partition.

3. The method of claim 1, further comprising:
determining that a first subset of the group of updated software components have corresponding existing software components in the read/write partition, wherein the storing the group of updated software components includes:
replacing the existing software components with the first subset of the group of updated software components.

4. The method of claim 1, further comprising:
determining that a second subset of the group of updated software components do not have corresponding existing software components in the read/write partition, wherein the storing the group of updated software components includes:
writing the second subset of the group of updated software components in the read/write partition;
creating a respective link associated with each software component of the second subset in the read-only partition.

5. The method of claim 1, further comprising:
during starting up of the BMC, obtaining, from the read-only partition, a first link associated with a first component of the firmware image stored in the read/write partition;
locating the first component in the read/write partition according to the first link; and
loading the first component from the read/write partition into a memory of the BMC.

6. A method of operating a baseboard management controller (BMC), comprising:
receiving, at the BMC, an update package containing one or more updated software components of a firmware image of the BMC;
determining that a first group of updated software components of the one or more updated software components are service components; and
creating a first layer on top of existing layers in an overlay file system, the first layer containing the first group of updated software components.

7. The method of claim 6, wherein a bottom layer of the overlay file system contains a kernel of the BMC.

8. The method of claim 7, wherein the bottom layer is stored in a read-only partition, wherein the first layer is stored in a read/write partition.

9. The method of claim 7, further comprising:
determining that a second group of updated software components of the one or more updated software components are core components of the BMC and include the kernel; and
flashing the bottom layer with the second group of updated software components.

10. The method of claim 6, further comprising:
determining that the one or more updated software components include an updated installation service component; and
prior to creating the first layer, creating, by an existing installation service component on top of the existing layers of the overlay file system, a second layer containing the updated installation service component.

11. The method of claim 10, further comprising:
executing the updated installation service component on the second layer, wherein the first layer is created by the updated installation service component.

12. The method of claim 6, further comprising:
during starting up of the BMC, providing a merged layer combing all layers of the overlay file system;
locating the first group of updated software components on the merged layer; and
loading the first group of updated software components from the merged layer into a memory of the BMC.

13. An apparatus, the apparatus being primary baseboard management controller (BMC), comprising:
a memory; and
at least one processor coupled to the memory and configured to:
receive, at the BMC, an update package containing one or more updated software components of a firmware image of the BMC;
determine that a first group of updated software components of the one or more updated software components are service components; and
create a first layer on top of existing layers in an overlay file system, the first layer containing the first group of updated software components.

14. The apparatus of claim 13, wherein a bottom layer of the overlay file system contains a kernel of the BMC.

15. The apparatus of claim 14, wherein the bottom layer is stored in a read-only partition, wherein the first layer is stored in a read/write partition.

16. The apparatus of claim 14, wherein the code is further configured to:
determine that a second group of updated software components of the one or more updated software components are core components of the BMC and include the kernel; and
flash the bottom layer with the second group of updated software components.

17. The apparatus of claim 13, wherein the code is further configured to:
determine that the one or more updated software components include an updated installation service component; and
prior to creating the first layer, create, by an existing installation service component on top of the existing layers of the overlay file system, a second layer containing the updated installation service component.

18. The apparatus of claim 17, wherein the code is further configured to:
execute the updated installation service component on the second layer, wherein the first layer is created by the updated installation service component.

19. The apparatus of claim 13, wherein the code is further configured to:
during starting up of the BMC, provide a merged layer combing all layers of the overlay file system;
locate the first group of updated software components on the merged layer; and
load the first group of updated software components from the merged layer into a memory of the BMC.
